(19) United States
(12) Patent Application Publication
(10) Pub. No.: US 2024/0226785 A9
(43) Pub. Date: Jul. 11, 2024

(54) HIGH PRESSURE FILTER APPARATUS WITH EXTERNAL SLEEVE AND RELATED METHODS

(71) Applicant: ENTEGRIS, INC., Billerica, MA (US)

(72) Inventors: Virendra Warke, North Chelmsford, MA (US); Benjamin Schooler, Belmont, MA (US)

(21) Appl. No.: 18/383,284

(22) Filed: Oct. 24, 2023

Related U.S. Application Data
(60) Provisional application No. 63/418,893, filed on Oct. 24, 2022.

(51) Int. Cl. B01D 35/30; B01D 29/11; B01D 29/33; B01D 46/00; B01D 46/24; C22B 9/02

(52) U.S. Cl. CPC B01D 35/30; B01D 29/111; B01D 29/33; B01D 46/0001; B01D 46/2407; C22B 9/023; B01D 2201/184; B01D 2201/202; B01D 2201/30; B01D 2265/04; B01D 2273/20

(57) ABSTRACT

Described are high pressure filter apparatuses that include first and second pieces having a welded seam along a circumference of the body, and a sleeve placed around and surrounding the welded seam.

### FIELD

This description relates to housings and apparatuses that are useful to contain a flow of fluid under high pressure.

### BACKGROUND

Across a very wide range of industries and applications, various types of fluid containers and fluid processing vessels are designed to contain a liquid or gaseous fluid at high pressure. Examples include isotactic press devices (see, e.g., United States Patent Application 2007/0218160), pressurized flow control structures (see, e.g., United States Patent Application 2013/0240062), and high pressure filter apparatuses (see e.g., United States Patent Application 2018/0193785).

The fluid container or vessel must be capable of containing a fluid either in a static condition or under a flow condition, at high pressure and for a sustained period. The container or vessel must be stable to the pressure and temperature conditions of the fluid and must be chemically stable and not degraded by the contained fluid. The container or vessel is constructed from components that fit together and form fluid-tight seals that prevent fluid from escaping the container or vessel interior.

The need for processing a flow of high pressure fluid extends across many industries, including chemical processing industries, automotive and aerospace industries, and the semiconductor manufacturing industry as a more specific example. According to these applications, a process of using the fluid can often require the fluid to be significantly free from impurities. Consequently, many systems that use a fluid at high pressure include a filter apparatus that removes impurities from the fluid while the fluid is in a pressurized condition.

Semiconductor manufacturing operations require high purity fluids for various processing steps. As an example, liquid tin is a type of molten metal that is used for producing extreme ultraviolet (EUV) radiation, which is used in photolithography processes. For use in a photolithography process, liquid tin should be free from impurities, contaminants, and particulates that can disrupt the process. Filtering the molten metal to remove impurities requires the molten metal to pass through a filter at a high pressure and a high temperature.

The filter and the flow of liquid metal must be contained in a filtering apparatus that is leak-proof at a temperature that can exceed 200 degrees Celsius, and at a pressure that can exceed 5,000 pounds per square inch, gauge (psig), or that exceeds a pressure of 8,000 psig or more. Certain filtering apparatus designs that are presently available can be useful at temperatures and pressures that approach or meet these ranges for filtering a fluid under pressure. But as with many commercial efforts, the need for improved performance is constant. Current or previous designs of high pressure filtering equipment must be continually improved to meet ever-higher performance requirements.

There is continuing need for filtration equipment that can be used for processing a fluid at high temperatures and pressures, e.g., for filtering various fluids such as molten metals and other types of liquids and gases.

### SUMMARY

Described are high pressure filter apparatuses that are capable of withstanding very high pressure without leaking or otherwise failing. A filter apparatus may include a fluid inlet at an inlet end, a fluid outlet at an outlet end, metal sidewalls between the fluid inlet and the fluid outlet, a filter chamber defined by the metal sidewalls, and a filter located in the filter chamber.

More specific examples can include multiple (at least two) housing pieces that are bonded together by a welded seam. These example assemblies can include the housing body having a welded seam, and an external sleeve that is placed over the housing body, optionally but not necessarily over the welded seam, to reinforce the body and allow the housing body to withstand a higher internal pressure during operation compared to the body without the welded seam.

Various known filtering systems exist that are useful for filtering a fluid at a high pressure and at high temperature. Some of these involve filter housing structures that are made of metal formed with a weld (including brazing). Welded structures are useful and can accommodate high internal pressures, but a welded seam in a pressure vessel can create a location of reduced strength. For example, welding a refractory metal or alloy can cause a reduction in material strength of as much as fifty percent due to re-crystallization.

As described herein, a separate sleeve piece is applied to an external surface of the housing body by sliding the sleeve over the outer surface of the housing body after preparing the outer surface to a smooth finish. The external sleeve may be heated to cause the sleeve to expand to fit over a filter housing. As the sleeve cools the sleeve, which may have an inner diameter that is smaller than an outer diameter of the housing body, may create a pre-strain on the housing body at ambient temperature. During use, with pressure contained in the housing body, the external sleeve can reduce the deformation of a welded seam under load, thus increasing its ultimate strength.

Because the sleeve reinforces the welded housing body, the material used to form the welded housing body can be selected for compatibility with a fluid that will contact the housing body during use. The sleeve may be made of a different material than that of the housing body. The material selected for the sleeve may be driven by stiffness and strength, while the material selected for the housing body may be driven by other characteristics such as weldability or material compatibility. The housing body may be prepared from a material that is compatible with a fluid passing through the body during use. The sleeve can be prepared from a material that has desired mechanical properties such as high tensile strength, modulus of elasticity, and ductility compared to the material of the wetted housing body.

According to one aspect, the description relates to a high pressure filter apparatus. The apparatus includes: a welded housing body that includes a fluid inlet, a fluid outlet, and a multi-piece welded housing body having a welded seam between the fluid inlet and the fluid outlet; a filter chamber; and a filter contained in the filter chamber. The apparatus further includes a sleeve that surrounds and applies pressure to the housing body.

According to another aspect, the description relates to a method of forming a high pressure filter product. The method includes providing: a filter; two or more housing piece that include a filter chamber, an inlet end, and an outlet end; securing the filter at a location within the filter chamber; welding the two or more housing pieces to form a housing body that includes one or more welded seams; and placing one or more sleeves around the housing body to surround the housing body.

According to another aspect, the description relates to a high pressure filter apparatus that includes: a fluid inlet at an inlet end, a fluid outlet at an outlet end, metal sidewalls between the fluid inlet and the fluid outlet, a filter chamber defined by the metal sidewalls, and a filter located in the filter chamber. The apparatus is capable of containing fluid in the filter chamber at a fluid pressure of at least 40,000 psig at 20 degrees Celsius without leaking.

### BRIEF DESCRIPTION OF THE FIGURES

FIGS. 1A, 1B, and 1C show assembled views of example filtering apparatuses as described.

FIG. 2A shows an assembled view of an example filtering apparatus as described.

FIG. 2B shows an example of an assembly step as described.

The figures are intended as non-limiting examples, are schematic, and are not necessarily to scale.

### DETAILED DESCRIPTION

Described are high pressure filter apparatuses that are capable of withstanding very high pressure without leaking or otherwise failing. Example apparatuses include a multi-piece welded housing (a.k.a., “welded housing body”) that includes two or more housing pieces, with at least one welded seam formed between two of the housing pieces. The weld is a known point of weakness in a welded housing body. To strengthen the welded housing body, the apparatus includes an external sleeve that is placed around the body, optionally at the welded seam to cover the welded seam and apply pressure to the housing body exterior at the welded seam. The welded housing body, reinforced by the sleeve, can withstand a higher interior pressure compared to the welded housing body without the sleeve.

An example housing body as described is made by assembling multiple, individual, structurally-separate pieces (“housing pieces”) into an assembled welded housing body by welding the separate pieces together at ends of the pieces to form a welded seam at the ends of the pieces. The two or more housing pieces are welded together at adjacent ends around the perimeters of the pieces such that the welded pieces form a continuous high pressure-resistant housing body that includes an interior with a filter chamber, an inlet connected to the filter chamber, and an outlet connected to the filter chamber. The welded housing body, having one or more welded seams, can withstand a significantly high interior pressure without leaking or otherwise failing. Still, for certain types of high pressure filtering applications, ever-higher levels of interior pressure within a housing body may be useful or advantageous, including levels of pressure that are too high for safe use due to a reduced strength at a welded seam.

The term “weld,” as in “welded seam,” refers to any manner of structurally attaching two opposed ends of two abutting housing body pieces by heating metal above a melting point and allowing the metal to cool and form a coalesced metal structure at the location of the seam, to structurally attach the two abutting ends to each other. The welding process includes any form of welding, including brazing, friction welding, soldering, or the like.

According to the present description, a reinforcing sleeve is placed over an exterior of a welded housing body to surround and reinforce the body, optionally to surround the welded seam, and allow the housing body to safely maintain an interior pressure that is greater than would be safely maintained by the welded housing body alone, in the absence of the reinforcing sleeve. The sleeve can be placed directly over the welded seam. Alternately, a sleeve may be placed over the body surface at a location that does not include the seam, without covering the seam, and will still provide a desired reinforcing effect to strengthen the housing body and increase the level of internal pressure that the body can withstand without causing a leak or other failure at the welded seam.

A housing of a high pressure filter apparatus can be designed and constructed of a range of metal materials, with a material of a specific housing body being selected to meet combined goals that may include strength of the material, and compatibility of the material with fluid used in a high pressure filtering process, particularly a fluid that will flow through and contact the interior of the housing body during use.

For a filter apparatus designed for processing a liquid metal at high pressure and temperature, a useful or preferred housing and its constituent pieces may be prepared from a refractory metal. Refractory metals can be thermally stable and chemically resistant. Molybdenum, for example, is able to withstand high temperatures (for example, above the freezing point of tin) without significant expansion or softening.

A challenge when using molybdenum and other refractory metals, however, is that the strength of a refractory metal can be significantly reduced upon welding, e.g., welded molybdenum may exhibit less than fifty percent of the strength of non-welded molybdenum.

To compensate for the reduced strength of a welded seam, example filter apparatuses as described use a reinforcing sleeve at an exterior of the body. Because the sleeve is present to increase the strength of the housing body, the strength of the housing body is de-emphasized as a factor in selecting the material used to form the housing body. The material of the housing body may advantageously be selected based on its compatibility with a fluid that will be contained by the device during operation, and need not be selected primarily to provide a specific level of mechanical strength. A housing body of a high pressure filter apparatus that contains a sleeve as described may be prepared from refractory metal such as a molybdenum, and may include a welded seam, yet is not limited by the reduced strength of the welded seam.

The external sleeve can be made of a non-welded material that applies pressure to the housing body as the body deforms during use from a high fluid pressure at the interior of the housing. The external sleeve acts to reduce or prevent deformation of a body, e.g., at the welded seam, under load, during use, thus increasing the overall strength of the housing body and allowing the housing to safely contain an increased interior pressure compared to a safe interior pressure in the absence of the sleeve.

A material of the non-welded sleeve may be selected based on mechanical properties such as high tensile strength, modulus of elasticity, and ductility, and the material is not required to be compatible with a fluid that flows through the housing interior.

Housing pieces of a multi-piece filter apparatus as described may be prepared from a large range of metal materials, including refractory metals (including alloys), alloys such as stainless steel, other metals such as nickel and nickel alloys, aluminum and aluminum alloys, cobalt and cobalt alloys, among others. Refractory metals include niobium, molybdenum, tantalum, tungsten, rhenium, and alloys that include one or more of these such as: an alloy that contains molybdenum and rhenium (MoRe), an alloy that contains tungsten and rhenium (WRe), an alloy that contains molybdenum and hafnium and carbon (MoHfC, or “MHC”), or an alloy that contains titanium and zirconium and molybdenum (TiZrMo).

A particular material for any of the different pieces may be selected based on factors that include: the need for certain mechanical properties such as strength and ductility; ease of processing, including the ability to form a weld using the material; and chemical compatibility with a fluid that will be contained by a filter apparatus during operation.

Advantageously, with the use of a sleeve as described to reinforce a housing body, the need to form the housing body from a high strength material can be de-emphasized. Instead of emphasizing a material's strength, a material for a housing body can be selected to emphasize compatibility of the material with fluid that will flow through and contact the housing body during use. For a filter apparatus designed to process a liquid metal at high pressure and temperature, a useful or preferred housing body and its constituent pieces may be made from refractory metal, including alloys thereof.

A reinforcing sleeve can be of any structure and material that can be incorporated into a high pressure filter apparatus as described, to be placed around a housing body to reinforce the housing body, optionally at the location of the welded seam.

Examples of useful or preferred sleeves can be in the form of a solid tubular structure that is in a rigid, tubular (e.g., cylindrical) form as the sleeve exists separate from the welded housing. The sleeve can be sized and structured to allow the sleeve to be installed at the outer surface of the welded housing body by sliding or “pressing” the sleeve along the length of the welded housing body, optionally to a location of a welded seam, so that the inner surface of the sleeve contacts the outer surface of the welded housing body optionally at the welded seam.

Example sleeves can be tubular and have dimensions of a length, an inner diameter and an outer diameter, and a thickness of the tubular wall. An example of a tubular wall structure can include a monolithic metal structure that extends the entire circumference and along the entire length of the sleeve. A “monolithic” structure means that the tubular sleeve wall includes at least one continuous, un-interrupted path of solid metal that extends around the full circumference of the sleeve, and at least one continuous, un-interrupted path of solid metal that extends along the length of the tubular sleeve. In specific, these example sleeves are formed of a single mass of metal that is continuous along the length and circumference, and are not formed of multiple discrete, segmented windings of one or more lengths of metal in the form of strands (wires or bands) that are wrapped around the exterior of the housing body.

Consistent therewith, if desired, the sleeve may include optional openings or apertures along the length and width and formed through the wall of tubular monolithic metal, with the apertured solid metal sleeve still being considered to be “monolithic” and including a continuous path of metal around the sleeve circumference and along the sleeve length. Alternately, an apparatus may include multiple (two or more) separate sleeves that are located at spaced locations at the exterior surface of a housing body along a length of the body, e.g., a housing body may include two welded seams with each of two separate sleeves being located to surround one of the two welded seams. According to these or other examples, an apparatus may include multiple sleeves in an overlapping arrangement, with two sleeves (with one sleeve that overlaps the other sleeve) being located at a same location along a length of the exterior surface of the body.

The sleeve of a filter apparatus as described may be prepared from a large range of metal materials, including refractory metals (including alloys), alloys such as stainless steel, other metals such as nickel and nickel alloys, aluminum and aluminum alloys, cobalt alloys, among others. Example sleeves may be prepared of a refractory metal that is the same as or different from a housing body made of refractory metal, e.g., any of: niobium, molybdenum, tantalum, tungsten, rhenium, and alloys that include one or more of these such as: an alloy that contains molybdenum and rhenium (MRe), an alloy that contains tungsten and rhenium (WRe), an alloy that contains molybdenum and hafnium and carbon (MoHfC, or “MHC”), or an alloy that contains titanium and zirconium and molybdenum (TiZrMo).

A sleeve of a particular filter apparatus may be prepared from any of these example materials, and in some example apparatuses may be selected to have a higher modulus of elasticity and a higher tensile strength than the housing body of the apparatus, with tungsten, molybdenum, and alloys thereof being examples of useful materials for a sleeve.

The sleeve can have a size and shape to allow the sleeve to be installed at the outer surface of the welded housing body by sliding or “pressing” the sleeve (optionally while the sleeve is heated) along the length of the welded housing body to a location of the welded seam.

In some example apparatuses, the sleeve can be sized to have an inner diameter that is slightly less than an outer diameter of a surface of the welded housing body. With a slightly smaller sleeve inner diameter compared to the welded housing body outer diameter, the installed sleeve will create a “pre-strained” condition of the housing body when installed. The amount of interference between the housing outer surface and the sleeve inner surface may be small, such as on a scale of thousandths or tens of thousandths of an inch, and a desired or useful amount of interference between the two surfaces may be selected based on the sizes of the sleeve and body, materials of the sleeve and body, and properties of the sleeve and body such the coefficients of thermal expansion of each of the sleeve and the body.

To produce a smaller inner diameter of the sleeve and a comparatively larger outer diameter of the outer surface of the housing body, the inner diameter of the sleeve may be curved or exhibit a slight “bulge” along the length, e.g., bowed inward toward the housing body to exhibit a minimum inner diameter at a middle portion of the length. Alternately, the outer surface of the housing body may be curved or exhibit a “bulge” along the length, e.g., bowed outward toward the sleeve to have a maximum diameter at a middle location of the length. By either arrangement, the diameter of the outer surface of the housing body is slightly larger than the diameter of the inner surface of the sleeve. The outer surface of the housing body interferes with the inner surface of the sleeve, and when the sleeve is installed at the outer surface of the housing body the smaller diameter of the sleeve causes the sleeve to exert pressure on the housing body at ambient conditions (e.g., room temperature, 22 degrees Celsius), before the interior of the housing body is pressurized during use. Upon pressurizing the interior of the housing body, the housing body will deform and expand slightly to a state that offsets the pre-strained condition of the housing body, and the pre-strained condition of the housing body will be transferred to the sleeve, which expands to a strained condition during use.

Examples of filter apparatuses that are constructed and assembled according to the present description can perform at significantly high pressures and significantly high temperatures, while the sleeve reinforces the housing body and prevents failure of the housing body, e.g., at a welded seam. Example high pressure filter apparatuses can be useful in a filtration process, e.g., for filtering fluid such as a molten metal, at pressures that reach or exceed 5,000 pounds per inch, gauge (psig), or that reach or exceed 10,000, 20,000 psig, 30,000 psig, or even 35,000, 40,000, 45,000, 50,000, 55,000, or 60,000 psig, or higher, at different temperature conditions, optionally at ambient temperature (20 degrees Celsius) or at a temperature that may reach or exceed 230 degrees Celsius, e.g., 250 or 300 degrees Celsius.

A filter apparatus can be measured for performance at high pressure and ambient temperature (room temperature), or at high pressure and an operating temperature, to assess a maximum internal pressure that the apparatus can withstand without failing; failure refers to a start of any amount of leaking from the housing such as at the welded seam. These tests are sometimes referred to as “burst tests,” and may be performed using water as a test fluid.

According to certain useful or preferred filter apparatuses as described, an apparatus may be capable of containing an interior of at least 40,000 psig, or at least 45,000 psig, at least 50,000 psig, at least 55,000 psig, or at least 60,000 psig, tested at 20 degrees Celsius. Also according to useful or preferred filter apparatuses as described, an apparatus may be capable of containing an interior pressure of at least 40,000 psig, or at least 45,000 psig, at least 50,000 psig, at least 55,000 psig, or at least 60,000 psig tested at an elevated (operating) temperature, e.g., a temperature of 200 degrees Celsius or higher, or 230 degrees Celsius or higher, or 300 degrees Celsius or higher.

Examples of useful or preferred sleeves can be in the form of a solid tubular structure that is in a tubular rigid form as the sleeve exists separate from the welded housing. By an example of a useful method, a tubular sleeve can be installed at an outer surface of a welded housing body by sliding or “pressing” the sleeve along the length of the welded housing body, for example to a location of a welded seam.

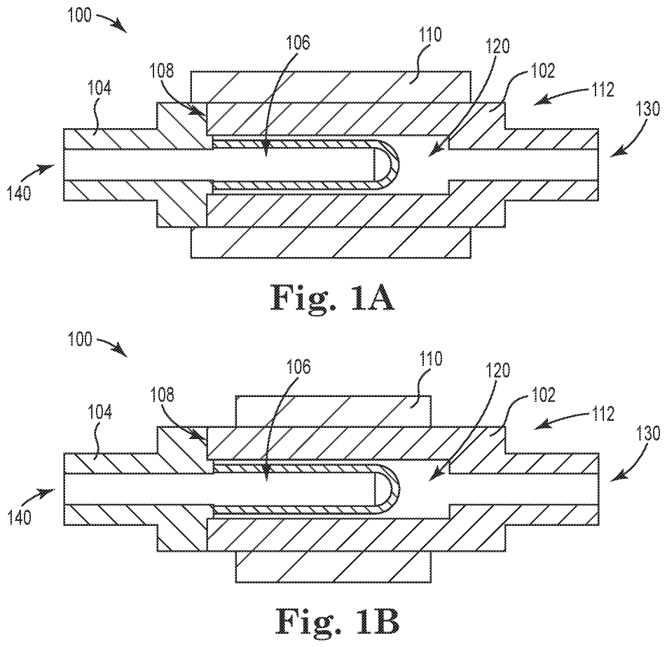

According to steps of preparing an apparatus as described, a welding housing body is prepared from housing pieces by forming a weld between two housing pieces. In a housing body that contains two pieces (see FIGS. 1A, 1B, and 1C), the housing body is made from two pieces that are welded together to form a single welded seam. Each piece includes an end that includes a flow opening, and a second end that engages and is welded to the other piece, a “welded end.” To form the housing body, an end of the first piece is welded to an end of the second piece to form a body that has a first fluid opening (e.g., inlet) at one end, a second fluid opening (e.g., outlet) at a second end, and a body portion formed by the welded pieces that contains the welded seam, and that contains a filter chamber and a filter contained in the filter chamber.

After forming the welded housing body, the outer surface is prepared to allow the sleeve to be installed at the outer surface of the housing body with substantially uniform contact between an inner surface of the sleeve and an outer surface of the welded housing body. Typically, a welded seam is processed by machining, grinding, abrading, lathing, polishing, or the like, to remove material of the weld to form a smooth outer surface of the welded seam. The outer surface of the welded housing body, including the location of the welded seam, can be made to be in the form of a smooth tubular (e.g., cylindrical) shape.

After processing the outer surface of the welded housing body to be suitably smooth, including at any welded seams, the sleeve can be installed over the outer surface. By one method, the sleeve can be caused to expand relative to the housing body to facilitate placing the sleeve over the housing body by sliding the sleeve over the housing body outer surface. To cause the sleeve to expand relative to the housing body, the sleeve can be heated, the housing body can be cooled, or both. After the heated sleeve is placed (e.g., “pressed”) over the welded housing body, the temperature of housing body and the temperature of the sleeve can be brought to equilibrium.

The welded housing (or “welded housing body”) contains a fluid inlet at one end, a fluid outlet at a second end, and is made of multiple (at least two) housing pieces that are welded together at adjacent ends (referred to as “welded ends”) to form one or more welded seams along the length of the housing body.

In certain example welded housing bodies, the housing body is made from two housing pieces. Each housing piece includes a tubular (e.g., cylindrical) portion to form the body, a fluid opening (inlet or outlet) at one end, and a second end that is referred to as a “welded end.” The housing body can be made by assembling and welding the two housing pieces to attach the welded end of the first housing piece to the welded end of the second housing piece to form a welded seam located along the length of the housing body, at the circumference of the housing body. The fluid inlet and fluid outlet of the two housing pieces become located at opposed ends of the housing body.

In alternate examples of welded housing bodies, the housing body is made from three housing pieces. A first housing piece, which may be referred to as an “end housing piece,” is a tubular piece that includes a fluid opening (inlet or outlet) at one end and a second end referred to as a welded end. A second housing piece, which may also be referred to as an “end housing piece,” is a tubular piece that includes a second fluid opening (inlet or outlet) at one end and a second end referred to as a welded end. A third housing piece is a tubular piece that may be referred to as a “middle piece,” that includes a first welded end and a second welded end. The housing body includes the first end housing piece welded to a welded end of the third piece (middle piece) at a welded seam located along the length of the housing body, and the second end housing piece welded to a second welded end of the third piece (middle piece) to form a second welded seam located along the length of the housing body. The fluid opening of the first end piece is located at one end of the welded housing body and the fluid opening of the second end piece is situated at at a second end of the welded housing body.

Referring to FIG. 1A, illustrated is a cut-away view of an example high pressure filter apparatus 100 as described. Apparatus 100 includes housing 112, which includes first housing piece 102, second housing piece 104, filter 106, welded seam 108, and sleeve 110. Sleeve 110 covers a portion of the outer surface of housing piece 102 and end piece 104, including welded seam 108, and applies pressure against the welded seam, a portion of the outer surface of housing piece 102, and a portion of the outer surface of end piece 104. Welded seam 108 is formed between an end (“welded end”) of piece 102 and an adjacent end (“welded end”) of piece 104, and may be a weld, which includes a braze or another structural attachment formed by heating metal and allowing the metal to coalesce as a welded seam that secures an end of piece 102 to an end of piece 104 and forms a fluid-tight seal at the interface between the ends of the two pieces. A welded seam can be a seam that is formed by any welding technique, including friction welding, as well as brazing, soldering, or the like.

As illustrated, apparatus 100 may be referred to as having a “front” end in a direction toward piece 104 and a “back” end in a direction toward piece 102. The terms “front” and “back” are for convenience when referring to features of apparatus 100 and do not refer to any structural requirement or manner of use of apparatus 100 such as a direction of flow of a fluid through apparatus 100, which can be in either direction between the front and the back of apparatus 100.

Housing piece 102 includes filter chamber 120 extending in a length-wise direction within an interior of housing piece 102, defined by interior surfaces of cylindrical sidewalls of housing piece 102. At one end (the “back” end) of housing piece 102 is first fluid flow opening 130, which leads to filter chamber 120. At the opposite end (the “front” end) of housing piece 102, housing piece 102 connects to an end (the “back” end) of housing piece 102 at weld 108, which extends around the circumference of housing pieces 102 and 104 to form a circular welded seam. At a front end of housing piece 102 is fluid flow opening 140, which also leads to filter chamber 120.

Filter 106 is adapted to fit within filter chamber 120 such that fluid that flows between fluid flow opening 130 and fluid flow opening 140, in either direction, must pass through filter 106.

Sleeve 110 is a solid a piece of metal in monolithic form, meaning that the sleeve is made of a single, integral, connected mass of metal and is not formed from multiple strands of metal wire or metal material wound to form a cylinder.

Referring to FIG. 1B, illustrated is a cut-away view of another example high pressure filter apparatus 100 as described. Apparatus 100 includes housing 112, which includes first housing piece 102, second housing piece 104, filter 106, welded seam 108, and sleeve 110. Welded seam 108 is formed between an end (“welded end”) of piece 102 and an adjacent end (“welded end”) of piece 104. Sleeve 110 covers a portion of the outer surface of housing piece 102, not including welded seam 108, and applies pressure against a portion of the outer surface of housing piece 102. While sleeve 110 does not cover welded seam 108, the sleeve still acts to reinforce and strengthen housing 112 of apparatus 100, to allow housing 112 to withstand an interior pressure that is greater than an interior pressure that would be withstood in the absence of sleeve 110.

Referring to FIG. 1C, illustrated is a cut-away view of another alternate example high pressure filter apparatus 100 as described. Apparatus 100 includes housing 112, which includes first housing piece 102, second housing piece 104, filter 106, welded seam 108, and sleeve 110. As shown at FIG. 1C, a weld 108 formed from welded ends of two housing pieces can be located at any desired location along the length of the housing, including at a location that is central to the housing as illustrated. Depending on overall design and materials, a welded seam at a central position of a length of a housing body as in FIG. 1C may be less strong than a welded seam that is located closer to an end of the body as in FIG. 1A. A sleeve located at or near a welded seam at a central position, as in FIG. 1C, may provide a relatively greater increase in strength to the housing body.

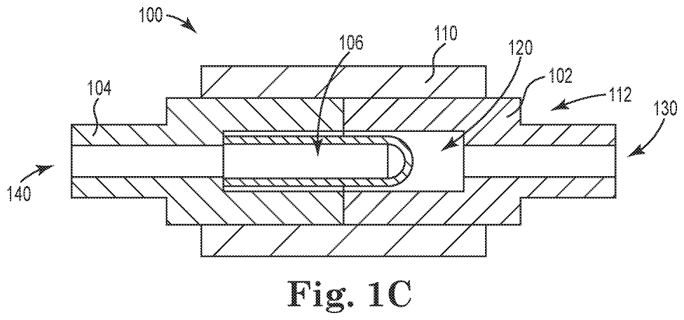

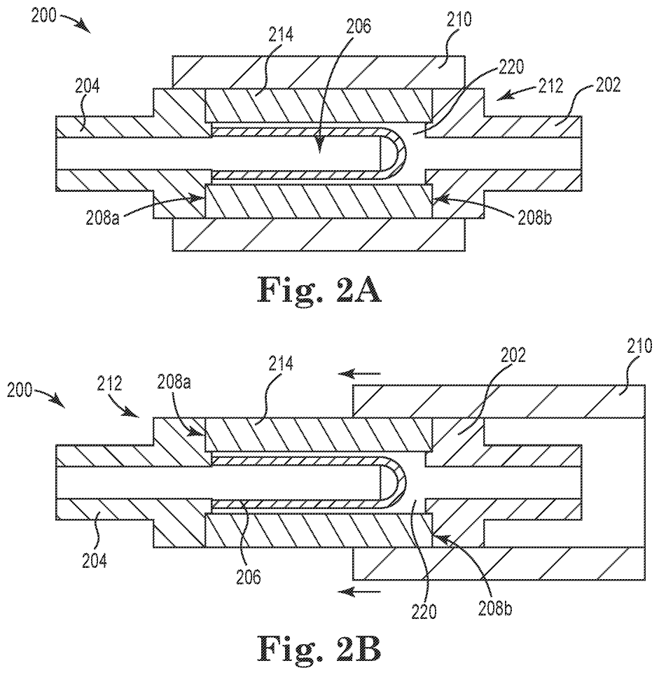

Referring to FIG. 2A, illustrated is a cut-away view of an alternate example high pressure filter apparatus 200 as described. Apparatus 200 includes housing 212, which includes first housing piece 202 (an “end piece”), second housing piece 204 (a second “end piece”), third housing piece (a “middle” piece) 214, filter 206, welded seams 208a and 208b, and sleeve 210. As illustrated, sleeve 210 covers welded seams 208a and 208b, a portion of end piece 202, and a portion of end piece 204, and applies pressure against the outer surfaces of end piece 202, enc piece 204, middle piece 214, and welded seams 208a and 208b. In alternate apparatuses, sleeve 110 does not need to cover both of welded seams 208a and 208b, and may cover and apply pressure only to a portion of middle piece 214, or to a portion of middle piece 214 and only one of welded seams 208a and 208b.

In assembled form, middle piece 214 defines filter chamber 220 between first end piece 202 and second end piece 204. A front end of end piece 202 is welded to a back end of middle piece 214 to form welded seam 208b. A back end of end piece 204 is welded to a front end of middle piece 214 to form welded seam 208a.

Middle piece 214 includes filter chamber 220 extending in a length-wise direction. At one end (the “back” end) of apparatus 200 is first fluid flow opening 230, which leads to filter chamber 220. At the opposite end (the “front” end) of apparatus 200 is fluid flow opening 240, which also leads to filter chamber 220. Filter 206 is adapted to fit within filter chamber 220 such that fluid that flows between fluid flow opening 230 and fluid flow opening 240, in either direction, must pass through filter 206.

Sleeve 210 is a solid a piece of metal in monolithic form, meaning that the sleeve is made of a single, integral, connected mass of metal and is not formed from multiple strands of metal wire or metal material wound to form a cylinder.

FIG. 2B shows an example of a step of assembling a high pressure filter apparatus. As shown, filter apparatus housing 212 is assembled from first housing piece 202 (an “end piece”), second housing piece 204 (a second “end piece”), third housing piece (a “middle” piece) 214, and filter 206, by forming a first welded seam 208a at adjacent ends of end piece 204 and middle piece, and by forming a second selded seam 208b at adjacent ends of end piece 202 and middle piece 214. After forming housing 212, sleeve 210 is placed over the exterior surface of housing 212 by sliding, e.g., pressing, sleeve 110 over the exterior surface, along the length of the exterior surface, to a desired location.

A “filter membrane” or (a.k.a., “filter element”) that may be held at an interior of a filter apparatus as described, to remove a contaminant from a flow of fluid that passes through the filter membrane, may be any useful filter membrane, including a type of filter membrane that is known for processing a fluid at a high temperature, a high pressure, or both.

The filter membrane may, for example, be a sintered porous filter element that is known to be useful for the filtration of liquid metals and gases at high pressure or temperature.

A useful filter membrane may have a pore sizes in a range from about 0.1 to about 5 microns, e.g., from about 0.5 to about 1.5 microns, as measured by bubble point per ASTM E128. Example filter membranes may be made from materials that include: titanium, tungsten, tantalum, molybdenum, niobium, alumina, titanium oxide, titanium nitride, and silicon carbide.

Filter elements of the present disclosure can be used for the filtration of a variety of liquid metals and gases. For example, filter elements of the present disclosure can be used to filter gases ranging from inert gases, such as argon, to corrosive gases, such as hydrogen bromide. Gases that can be filtered include, for example, argon, nitrogen, carbon dioxide, hydrogen bromide, and hydrogen chloride, and hydrides. Filter elements of the present disclosure can also be used to filter supercritical fluids, such as carbon dioxide in a supercritical state.

A filter apparatus as described can be used to filter gases and liquids, including molten metals (“liquid metals”). Metals that can be filtered include tin, lead, sodium, cadmium, selenium, mercury, and, in general, materials that melt below about 400 degrees Celsius. Gases that can be processed at high temperatures and pressures include argon, nitrogen (N₂), hydrogen bromide (HBr), hydrogen chloride (HCl), and carbon dioxide (CO₂), as non-limiting examples.

Following are Aspect apparatuses and methods of the present description.
Aspect 1. A high pressure filter apparatus comprising:
   a welded housing body comprising:
      a fluid inlet, a fluid outlet, and a multi-piece welded housing body comprising a welded seam between the fluid inlet and the fluid outlet,
      a filter chamber and a filter contained in the filter chamber, and
   a sleeve that surrounds and applies pressure to the housing body.
Aspect 2. The filter apparatus of Aspect 1, wherein the sleeve surrounds the welded seam.
Aspect 3. The filter apparatus of Aspect 1 or 2, comprising:
a first housing piece comprising the fluid inlet and a welded end at the welded seam,
a second housing piece comprising the fluid outlet and a welded end at the welded seam.
Aspect 4. The filter apparatus of Aspect 1 or 2, comprising:
a first housing piece comprising the fluid inlet and a welded end at a first welded seam,
a second housing piece comprising the fluid outlet and a welded end at a second welded seam, and
a third housing piece comprising a first welded end at the first welded seam and a second welded end at the second welded seam.
Aspect 5. The filter apparatus of any of Aspects 1 through 4, wherein the welded housing body comprises refractory metal.
Aspect 6. The filter apparatus of any of Aspects 1 through 5, wherein the welded housing body comprises: niobium, molybdenum, tantalum, tungsten, rhenium, or an alloy thereof.
Aspect 7. The filter apparatus of any of Aspects 1 through 6, wherein the sleeve comprises a metal band.
Aspect 8. The filter apparatus of Aspect claim 7, wherein the sleeve comprises refractory metal, tungsten, molybdenum, stainless steel, nickel, cobalt, or an alloy thereof.
Aspect 9. The filter apparatus of Aspect 7 or 8, wherein the metal band has higher modulus of elasticity than the welded housing body, higher tensile strength than the welded housing body, or both.
Aspect 10. The filter apparatus of any of Aspects 1 through 9, wherein the filter comprises: titanium, silicon carbide, tungsten, tantalum, molybdenum, niobium, alumina, titanium oxide, or titanium nitride.
Aspect 11. The filter apparatus of any of Aspects 1 through 10, wherein the sleeve has an inner diameter that is less than an outer diameter of the housing body.
Aspect 12. The filter apparatus of Aspect 11, wherein the sleeve has an inner diameter that varies along a length of the sleeve, including a minimum diameter at a location between the ends of the sleeve.
Aspect 13. The filter apparatus of Aspect 11 or 12, wherein the housing body has an outer diameter that varies along a length of the sleeve, including a maximum diameter at a location between the ends of the sleeve.
Aspect 14. The filter apparatus of any of Aspects 1 through 13, wherein the filter has an average pore size in a range from 0.1 to 5 microns.
Aspect 15. The filter apparatus of any of Aspects 1 through 14, wherein the apparatus is capable of containing fluid in the filter chamber at a fluid pressure of at least 40,000 psig without leaking.
Aspect 16. The filter apparatus of any of Aspects 1 through 15, wherein the apparatus is capable of containing fluid in the filter chamber at a fluid pressure of at least 45,000 psig without leaking.
Aspect 17. The filter apparatus of Aspect 15 or 16, wherein the apparatus is capable of containing fluid in the filter chamber at a fluid temperature of at least 230 degrees Celsius without leaking.
Aspect 18. The filter apparatus of Aspect 15 or 16, wherein the apparatus is capable of containing fluid in the filter chamber at a fluid temperature of at least 230 degrees Celsius without leaking.
Aspect 19. A method of filtering a fluid, the method comprising:
providing a high pressure filter product according to any of claims 1 through 18, and
passing fluid that contains an impurity through the filter to cause the impurity to be removed from the fluid.
Aspect 20. The method of Aspect 19, comprising passing the fluid through the filter chamber at a fluid pressure of at least 40,000 psig.
Aspect 21. The method of Aspect 19 or 20, comprising passing the fluid through the filter chamber at a fluid temperature of at least 230 degrees Celsius.
Aspect 22. A method of forming a high pressure filter product, the method comprising:
providing:
   a filter,
   two or more housing piece that comprise a filter chamber, an inlet end, and an outlet end,
securing the filter at a location within the filter chamber,
welding the two or more housing pieces to form a housing body that includes one or more welded seams, and
placing one or more sleeves around the housing body to surround the housing body.
Aspect 23. The method of Aspect 22, comprising placing one or more sleeves over one or more welded seams, to surround the one or more welded seams.
Aspect 24. The method of Aspect 22 or 23, comprising processing the one or more welded seams to form a smooth welded seam surface.
Aspect 25. The method of any of Aspects 22 through 24, comprising sliding the one or more sleeves over the housing body.
Aspect 26. A method of any of Aspects 22 through 25, wherein placing the sleeve over the housing body comprises:
heating the sleeve to expand the sleeve,
sliding the expanded sleeve over the housing body, and
allowing the expanded sleeve to cool and contract over the housing body.
Aspect 27. A high pressure filter apparatus comprising:
a fluid inlet at an inlet end,
a fluid outlet at an outlet end,
metal sidewalls between the fluid inlet and the fluid outlet,
a filter chamber defined by the metal sidewalls, and
a filter located in the filter chamber,
   wherein the apparatus is capable of containing fluid in the filter chamber at a fluid pressure of at least 40,000 psig without leaking.
Aspect 28. The filter apparatus of Aspect 25, wherein the apparatus is capable of containing the fluid in the filter chamber at a fluid pressure of at least 45,000 psig without leaking.
Aspect 29. The filter apparatus of Aspect 27 or 28, wherein the apparatus is capable of containing the fluid in the filter chamber at a fluid temperature of at least 230 degrees Celsius without leaking.
Aspect 30. The filter apparatus of any of Aspects 27 through 29, wherein the metal sidewalls comprise a refractory metal.
Aspect 31. The filter apparatus of any of Aspects 27 through 30, wherein the metal sidewalls do not include a welded seam.
Aspect 32. The filter apparatus of any of Aspects 27 through 31, wherein the filter comprises: titanium, silicon carbide, tungsten, tantalum, molybdenum, niobium, alumina, titanium oxide, or titanium nitride.
Aspect 33. The filter apparatus of any of Aspects 27 through 32, wherein the filter has an average pore size in a range from 0.1 to 5 microns.

1. A high pressure filter apparatus comprising:
a welded housing body comprising:
a fluid inlet, a fluid outlet, and a multi-piece welded housing body comprising a welded seam between the fluid inlet and the fluid outlet,
a filter chamber and a filter contained in the filter chamber, and
a sleeve that surrounds and applies pressure to the housing body.

2. The filter apparatus of claim 1, wherein the sleeve surrounds the welded seam.

3. The filter apparatus of claim 1, comprising:
a first housing piece comprising the fluid inlet and a welded end at the welded seam,
a second housing piece comprising the fluid outlet and a welded end at the welded seam.

4. The filter apparatus of claim 1, comprising:
a first housing piece comprising the fluid inlet and a welded end at a first welded seam,
a second housing piece comprising the fluid outlet and a welded end at a second welded seam, and
a third housing piece comprising a first welded end at the first welded seam and a second welded end at the second welded seam.

5. The filter apparatus of claim 1, wherein the welded housing body comprises refractory metal.

6. The filter apparatus of claim 1, wherein the welded housing body comprises: niobium, molybdenum, tantalum, tungsten, rhenium, or an alloy thereof.

7. The filter apparatus of claim 1, wherein the sleeve comprises a metal band.

8. The filter apparatus of claim 7, wherein the sleeve comprises refractory metal, tungsten, molybdenum, stainless steel, nickel, cobalt, or an alloy thereof.

9. The filter apparatus of claim 7, wherein the metal band has higher modulus of elasticity than the welded housing body, higher tensile strength than the welded housing body, or both.

10. The filter apparatus of claim 1, wherein the filter comprises: titanium, silicon carbide, tungsten, tantalum, molybdenum, niobium, alumina, titanium oxide, or titanium nitride.

11. The filter apparatus of claim 1, wherein the sleeve has an inner diameter that is less than an outer diameter of the housing body.

12. The filter apparatus of claim 11, wherein the sleeve has an inner diameter that varies along a length of the sleeve, including a minimum inner diameter at a location between the ends of the sleeve.

13. The filter apparatus of claim 11, wherein the housing body has an outer diameter that varies along a length of the sleeve, including a maximum inner diameter at a location between the ends of the sleeve.

14. The filter apparatus of claim 1, wherein the filter has an average pore size in a range from 0.1 to 5 microns.

15. The filter apparatus of claim 1, wherein the apparatus is capable of containing fluid in the filter chamber at a fluid pressure of at least 40,000 psig at 20 degrees Celsius without leaking.

16. The filter apparatus of claim 1, wherein the apparatus is capable of containing fluid in the filter chamber at a fluid pressure of at least 45,000 psig at 20 degrees Celsius without leaking.

17. The filter apparatus of claim 15, wherein the apparatus is capable of containing fluid in the filter chamber at a fluid temperature of at least 230 degrees Celsius without leaking.

18. A method of filtering a fluid, the method comprising:
providing a high pressure filter product according to any of claims 1 through 18, and
passing fluid that contains an impurity through the filter to cause the impurity to be removed from the fluid.

19. The method of claim 18, comprising passing the fluid through the filter chamber at a fluid pressure of at least 40,000 psig at 20 degrees Celsius.

20. The method of claim 18, comprising passing the fluid through the filter chamber at a fluid temperature of at least 230 degrees Celsius.

21. A method of forming a high pressure filter product, the method comprising:
providing:
a filter,
two or more housing piece that comprise a filter chamber, an inlet end, and an outlet end,
securing the filter at a location within the filter chamber,
welding the two or more housing pieces to form a housing body that includes one or more welded seams, and
placing one or more sleeves around the housing body to surround the housing body.

22. The method of claim 21, comprising placing one or more sleeves over one or more welded seams, to surround the one or more welded seams.

23. The method of claim 21, comprising processing the one or more welded seams to form a smooth welded seam surface.

24. The method of claim 21, comprising sliding the one or more sleeves over the housing body.

25. A method of claim 21, wherein placing the sleeve over the housing body comprises:
heating the sleeve to expand the sleeve,
sliding the expanded sleeve over the housing body, and
allowing the expanded sleeve to cool and contract over the housing body.

26. A high pressure filter apparatus comprising:
a fluid inlet at an inlet end,
a fluid outlet at an outlet end,
metal sidewalls between the fluid inlet and the fluid outlet,
a filter chamber defined by the metal sidewalls, and
a filter located in the filter chamber,
wherein the apparatus is capable of containing fluid in the filter chamber at a fluid pressure of at least 40,000 psig at 20 degrees Celsius without leaking.

27. The filter apparatus of claim 26, wherein the apparatus is capable of containing the fluid in the filter chamber at a fluid pressure of at least 45,000 psig at 20 degrees Celsius without leaking.

28. The filter apparatus of claim 26, wherein the apparatus is capable of containing the fluid in the filter chamber at a fluid temperature of at least 230 degrees Celsius without leaking.

29. The filter apparatus of claim 26, wherein the metal sidewalls comprise a refractory metal.

30. The filter apparatus of claim 26, wherein the metal sidewalls do not include a welded seam.

31. The filter apparatus of claim 26, wherein the filter comprises: titanium, silicon carbide, tungsten, tantalum, molybdenum, niobium, alumina, titanium oxide, or titanium nitride.

32. The filter apparatus of claim 26, wherein the filter has an average pore size in a range from 0.1 to 5 microns.
